(19) United States
(12) Patent Application Publication
(10) Pub. No.: US 2014/0068134 A1
(43) Pub. Date: Mar. 6, 2014

(54) DATA TRANSMISSION APPARATUS, SYSTEM, AND METHOD

(71) Applicant: Huawei Technologies Co., Ltd., Shenzhen (CN)

(72) Inventor: Xuequan SUN, Beijing (CN)

(73) Assignee: Huawei Technologies Co., Ltd., Shenzhen (CN)

(21) Appl. No.: 14/012,672

(22) Filed: Aug. 28, 2013

(30) Foreign Application Priority Data
Aug. 28, 2012 (CN) 201210309283.9

(51) Int. Cl. G06F 13/32

(52) U.S. Cl. CPC G06F 13/32
USPC 710/308

(57) ABSTRACT

Embodiments of the present invention provide a data transmission apparatus, system, and method. The apparatus includes: a data transit module, configured to read configuration information of a first sending buffer of a first processor core, and when the configuration information indicates that the first sending buffer stores data to be transmitted to a receiving buffer of a second processor core, control a DMA module to transmit the data from the first sending buffer to the receiving buffer, and set interrupt information; and an interrupt management module, configured to read the interrupt information, and when the interrupt information indicates that an interrupt needs to be triggered to the second processor core, control a multi-core interrupt controller to trigger the interrupt to the second processor core, to enable the second processor core to process the data in the receiving buffer.

### CROSS-REFERENCE TO RELATED APPLICATIONS

This application claims priority to Chinese Patent Application No. 201210309283.9, filed on Aug. 28, 2012, which is hereby incorporated by reference in its entirety.

### TECHNICAL FIELD

The present invention relates to the field of computers and communications, and in particular, to a data transmission apparatus, system, and method.

### BACKGROUND

At present, both a mainframe and a personal computer (Personal Computer, PC) of the x86 architecture start employing a multi-core architecture. For example, two-core and four-core have become common configurations for current PCs. Moreover, with the fast development of multimedia audio-video applications, higher requirements on processing a large amount of data, and a tremendous development of the processor technology, an embedded micro-processor is also developed toward two, four, and more cores. Accordingly, all the mainstream processor architectures, from the most advanced server processor to the embedded processor sensitive to power consumption, are on the way of developing toward multiple cores.

The data processing process between multiple cores is impossibly independent completely, and requires collaborative processing, and the collaboration between multiple cores requires transmission of a large amount of data between each other. The current common inter-core communication method is to use a sending processor core or a receiving processor core to perform operations such as data transit and data interrupt. Consequently, consumption of each core in the inter-core communication continuously increases with the increase of the amount of the transmitted data, which causes that a part of services cannot be normally processed, thereby seriously reducing the service processing capability of the processor core.

### SUMMARY

Embodiments of the present invention provide a data transmission apparatus, system, and method, which are capable of reducing consumption of processor cores in an inter-core communication process, and enhancing service processing capabilities of the processor cores.

In a first aspect, a data transmission apparatus is provided, including: a data transit module, configured to read configuration information of a first sending buffer of a first processor core, and when the configuration information indicates that the first sending buffer stores data to be transmitted to a receiving buffer of a second processor core, control a direct memory access DMA module to transmit the data from the first sending buffer to the receiving buffer, and set interrupt information; and an interrupt management module, configured to read the interrupt information, and when the interrupt information indicates that an interrupt needs to be triggered to the second processor core, control a multi-core interrupt controller to trigger the interrupt to the second processor core, to enable the second processor core to process the data in the receiving buffer.

With reference to the first aspect, in a first possible implementation manner, the apparatus further includes a configuration register, configured to store the configuration information and the interrupt information; the data transit module is specifically configured to read the configuration information from the configuration register, and store the interrupt information into the configuration register; and the interrupt management module is specifically configured to read the interrupt information from the configuration register.

With reference to the first possible implementation manner in the first aspect, in a second possible implementation manner, the apparatus further includes a priority arbitration module; the configuration register is further configured to store priority information, the priority information including a priority of each sending buffer; the priority arbitration module is configured to select the first sending buffer from a plurality of sending buffers storing the data to be transmitted according to the priority information, and send indication information for indicating the first sending buffer to the data transit module, where the first sending buffer has the highest priority in the plurality of sending buffers storing the data to be transmitted; and the data transit module is specifically configured to read the configuration information of the first sending buffer from the configuration register according to the indication information.

With reference to the first aspect or the first possible implementation manner in the first aspect or the second possible implementation manner in the first aspect, in a third possible implementation manner, the interrupt management module is specifically configured to control, when the interrupt information indicates that data amount in the receiving buffer is greater than or equal to a data amount threshold, the multi-core interrupt controller to trigger an interrupt to the second processor core; or the interrupt management module is specifically configured to control, when a time length of an interrupt time threshold indicated by the interrupt information expires, the multi-core interrupt controller to trigger the interrupt to the second processor core; or the interrupt management module is specially configured to control, when the interrupt information indicates that the data has been transmitted from the first sending buffer to the receiving buffer, the multi-core interrupt controller to trigger the interrupt to the second processor core.

With reference to the first aspect or the first possible implementation manner in the first aspect or the second possible implementation manner in the first aspect or the third possible implementation manner in the first aspect, in a fourth possible implementation manner, the apparatus further includes the DMA module.

With reference to the first aspect or the first possible implementation manner in the first aspect or the second possible implementation manner in the first aspect or the third possible implementation manner in the first aspect or the fourth possible implementation manner in the first aspect, in a fifth possible implementation manner, the apparatus further includes: a coding module, a processing buffer, and a Cyclic Redundancy Check CRC generation module; the data transit module is specifically configured to control the DMA module to transmit the data from the first sending buffer to the processing buffer; the coding module is configured to code the data, and transmit the coded data to the CRC generation module; the CRC generation module is configured to perform CRC check on the coded data, and store the data after the CRC check in the processing buffer; and the data transit module is specifically configured to control the DMA module to transmit the data after the CRC check from the processing buffer to the receiving buffer.

With reference to the first aspect or the first possible implementation manner in the first aspect or the second possible implementation manner in the first aspect or the third possible implementation manner in the first aspect or the fourth possible implementation manner in the first aspect or the fifth possible implementation manner in the first aspect, in a sixth possible implementation manner, the apparatus further includes: an integrity detection module, configured to perform, before the data transit module controls the DMA module to transmit the data from the first sending buffer to the receiving buffer, integrity detection on the data.

In a second aspect, a data transmission system is provided, which includes: at least two processor cores, a multi-core interrupt controller, and a data transmission apparatus, where a first processor core in the at least two processor cores is configured with at least one sending buffer, a second processor core in the at least two processor cores is configured with at least one receiving buffer; the at least two processor cores, the at least one sending buffer, the at least one receiving buffer, the multi-core interrupt controller, and the apparatus are connected through a bus; the first processor core is configured to write data to be transmitted to a first receiving buffer in the at least one receiving buffer into a first sending buffer in the at least one sending buffer; the apparatus is configured to control, when the configuration information of the first sending buffer indicates that the first sending buffer stores the data to be transmitted to the first receiving buffer, a direct memory access DMA module to transmit the data from the first sending buffer to the first receiving buffer, and set interrupt information; the apparatus is further configured to control, when the interrupt information indicates that an interrupt needs to be triggered to the second processor core, a multi-core interrupt controller to trigger the interrupt to the second processor core; and the second processor core is configured to process the data in the first receiving buffer in response to the interrupt triggered by the apparatus.

With reference to the second aspect, in a first possible implementation manner, the system further includes: the direct memory access DMA module, connected to the at least two processor cores, the at least one sending buffer, the at least one receiving buffer, the multi-core interrupt controller, and the apparatus through a bus.

With reference to the second aspect or the first possible implementation manner in the second aspect, in a second possible implementation manner, the system further includes a serial interface, and the system is connected to another system through the serial interface; the apparatus is further configured to code the data to be transmitted stored in the plurality of sending buffers, and transmit the coded data to a receiving buffer of the at least one receiving buffer to acquire aggregated data; and the serial interface is configured to read the aggregated data, and transmit the aggregated data to the another system.

In a third aspect, a data transmission method is provided, including: reading configuration information of a first sending buffer of a first processor core, and when the configuration information indicates that the first sending buffer stores data to be transmitted to a receiving buffer of a second processor core, controlling a direct memory access DMA module to transmit the data from the first sending buffer to the receiving buffer, and setting interrupt information; and reading the interrupt information, and when the interrupt information indicates that an interrupt needs to be triggered to the second processor core, controlling a multi-core interrupt controller to trigger the interrupt to the second processor core, to enable the second processor core to process the data in the receiving buffer.

With reference to the third aspect, in a first possible implementation manner, the first sending buffer is selected from the plurality of sending buffers storing the data to be transmitted according to priority information, where the first sending buffer has the highest priority in the plurality of sending buffers storing the data to be transmitted, and the priority information includes a priority of each sending buffer.

With reference to the third aspect or the first possible implementation manner in the third aspect, in a second possible implementation manner, when the interrupt information indicates that data amount in the receiving buffer is greater than or equal to a data amount threshold, the multi-core interrupt controller is controlled to trigger the interrupt to the second processor core; or when a time length of an interrupt time threshold indicated by the interrupt information expires, the multi-core interrupt controller is controlled to trigger the interrupt to the second processor core; or when the interrupt information indicates that the data has been transmitted from the first sending buffer to the receiving buffer, the multi-core interrupt controller is controlled to trigger the interrupt to the second processor core.

With reference to the third aspect or the first possible implementation manner in the third aspect or the second possible implementation manner in the third aspect, in a third possible implementation manner, the DMA module is controlled to transmit the data from the first sending buffer to a processing buffer; the data is coded; CRC check is performed on the coded data, the data after the CRC check is stored in the processing buffer; and the DMA module is controlled to transmit the data after the CRC check from the processing buffer to the receiving buffer.

With reference to the third aspect or the first possible implementation manner in the third aspect or the second possible implementation manner in the third aspect or the third possible implementation manner in the third aspect, in a fourth possible implementation manner of the third aspect, before the DMA module is controlled to transmit the data from the first sending buffer to the receiving buffer, integrity detection is performed on the data.

In the embodiments of the present invention, the data transit module controls the DMA module to transmit the data from the first sending buffer of the first processor core to the receiving buffer of the second processor core, and the interrupt management module controls the multi-core interrupt controller to trigger the interrupt to the second processor core. In this way, the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

### BRIEF DESCRIPTION OF DRAWING

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and persons of ordinary skill in the art may still derive other drawings from the accompanying drawings without creative efforts.

FIG. 1 is a schematic block diagram of a data transmission apparatus according to an embodiment of the present invention;

FIG. 2 is a schematic block diagram of a data transmission apparatus according to another embodiment of the present invention;

FIG. 3 is a schematic block diagram of a data transmission system according to an embodiment of the present invention;

FIG. 4 is a schematic flow chart of an example of transmitting data between systems according to an embodiment of the present invention; and

FIG. 5 is a schematic flow chart of a data transmission method according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

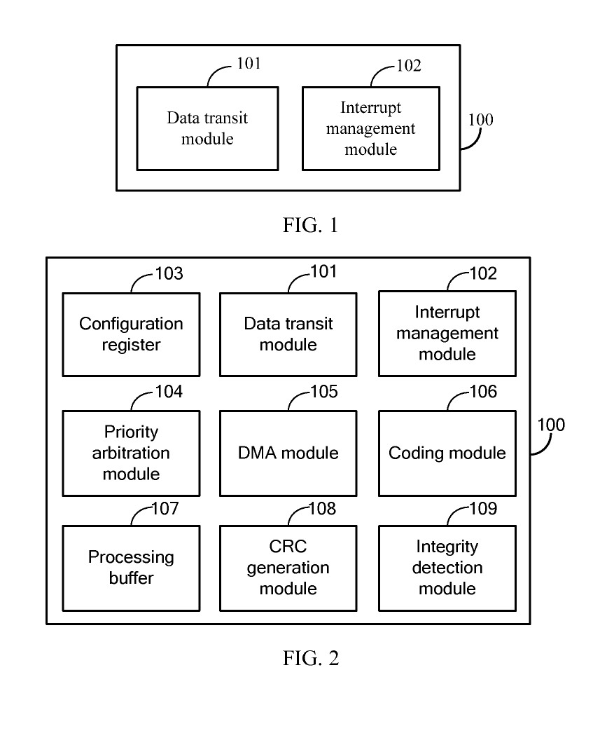

FIG. 1 is a schematic block diagram of a data transmission apparatus according to an embodiment of the present invention.

An apparatus 100 in FIG. 1 includes a data transit module 101 and an interrupt management module 102. The data transit module 101 is configured to read configuration information of a first sending buffer of a first processor core, and when the configuration information indicates that the first sending buffer stores data to be transmitted to a receiving buffer of a second processor core, control a direct memory access (Direct Memory Access, DMA) module to transmit the data from the first sending buffer to the receiving buffer, and set interrupt information. The interrupt management module 102 is configured to read the interrupt information, and when the interrupt information indicates that an interrupt needs to be triggered to the second processor core, control a multi-core interrupt controller to trigger the interrupt to the second processor core, to enable the second processor core to process the data in the receiving buffer.

The interrupt information herein is a signal in an interrupt mechanism in a multi-core system, and the second processor core can execute other operations before receiving the interrupt signal; and upon receiving the interrupt signal, the second processor core may start processing the data in the receiving buffer.

In the embodiments of the present invention, the data transit module controls the DMA module to transmit the data from the first sending buffer of the first processor core to the receiving buffer of the second processor core, and the interrupt management module controls the multi-core interrupt controller to trigger the interrupt to the second processor core, so that the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

Moreover, since the first processor core and the second processor core do not need to perform relevant operations of data transmission and interrupt triggering in the inter-core communication process, a huge throughput is provided, thereby ensuring real-time data transmission between the multiple processor cores, and ensuring real-time processing of the service.

Optionally, as an embodiment, as shown in FIG. 2, the apparatus 100 may further include a configuration register 103, which may be configured to store configuration information and interrupt information. The data transit module 101 may read the configuration information from the configuration register 103, and store the interrupt information into the configuration register 103. The interrupt management module 102 may read the interrupt information from the configuration register 103.

For example, the number of the configuration register 103 may be one, and the configuration information and the interrupt information are both stored in the configuration register. The configuration register 103 may include two registers, and the configuration information and the interrupt information may be stored in different registers respectively, which are not limited in the embodiment of the present invention.

It should be noted that, in an initial state of a multi-core system, each processor core may configure its own sending buffers and/or receiving buffers, to generate the configuration information of the sending buffer and/or the configuration information of the receiving buffers, and store the configuration information in the configuration register 103. Moreover, a master processor core is determined from the plurality of processor cores, and the master processor core configures each sending buffer and each receiving buffer, to generate the configuration information of the sending buffers and the configuration information of the receiving buffers.

It should be understood that, the configuration register 103 may not only be configured to store the configuration information of the first sending buffer of the first processor core, but may also be configured to store the configuration information of all the sending buffers of the processor core, and may also be configured to store the configuration information of all the receiving buffers of the processor core. The configuration register 103 may further include a plurality of registers, and the configuration information of the sending buffers and the configuration information of the receiving buffers and the interrupt information may be stored in different registers respectively, which are not limited in the embodiment of the present invention.

The sending buffer and the receiving buffer may both be ring buffers. The configuration information of the sending buffers may include relevant attributes of the sending buffers, and the configuration information of the receiving buffers may include relevant attributes of the receiving buffer.

The sending buffer may have the following attributes: an initial physical address, a byte length, a read pointer, a write pointer, a receiving buffer identity (Identity, ID), and an enable flag. The receiving buffer ID is used to identify a data transmission destination of the sending buffer, and the ID also implies the ID of the processor core to which the receiving buffer belongs. The enable flag is used to indicate whether the sending buffer is in an enabled state, and only the data in the sending buffer in the enabled state will be processed by the data transit module.

The receiving buffer may have the following attributes: an initial physical address, a byte length, a read pointer, and a write pointer.

The first processor core may execute a data write operation, for example, write data to be transmitted into the first sending buffer, and update the write pointer of the first sending buffer.

The data transit module 101 may control the DMA module to execute the data transmission process between the processor cores, for example, the data transit module 101 may configure in the DMA module the relevant information of the data to be transmitted, enable the DMA module, and so on, so that the DMA module executes the data transmission operation between the first processor core and the second processor core. Moreover, the data transit module 101 may set the interrupt information. In addition, the data transit module 101 may further update the read pointer of the first sending buffer and the write pointer of the receiving buffer.

The interrupt management module 102 may control, according to the interrupt information, the multi-core interrupt controller to trigger the interrupt to the processor core receiving the data. The multi-core interrupt controller may be responsible for executing an interrupt triggering operation. For example, the multi-core interrupt controller may be an IPCM or a Mailbox of an ARM, and the like.

The second processor core may process the data in the receiving buffer in response to the interrupt of the multi-core interrupt controller, and may also update the read pointer of the receiving buffer.

It can be seen that, the data transit module 101 is responsible for executing the data transmission operation and the interrupt management module 102 is responsible for executing the interrupt operation after the data transmission, so that the first processor core and the second processor core do not need to perform relevant operations such as data transmission and interrupt. Therefore, in the inter-core communication process, the first processor core only needs to execute the data write operation, and the second processor core only needs to execute the data processing operation in response to the interrupt, thereby reducing CPU (Central Processing Unit, central processing unit) usage rate of the processor core. Accordingly, consumption of the processor cores in an inter-core communication process is reduced, service processing capabilities of the processor cores are enhanced, and data transmission rate between the multiple processor cores is improved.

The present invention is directed to overcoming the defect in the prior art that the priority of sending the data in the sending buffer is controlled by the priority of the sending task instead of being controlled according to the importance degree of the data itself, which causes that the importance data cannot be sent in priority.

Optionally, as an embodiment, as shown in FIG. 2, the apparatus 100 may further include a priority arbitration module 104.

The configuration register 103 may be further configured to store priority information, and the priority information may include a priority of each sending buffer. The priority arbitration module 104 may select the first sending buffer from all the sending buffers storing the data to be transmitted according to the priority information, and send the indication information for indicating the first sending buffer to the data transit module 101, where the first sending buffer has the highest priority in all the sending buffers storing the data to be transmitted. The data transit module 101 may further read the configuration information of the first sending buffer from the configuration register 103 according to the indication information.

It should be understood that, the above first processor core may further include at least one sending buffer, and the attributes of each sending buffer may further include the priority. When needing to send data to the second processor core, the first processor core may write the data into the sending buffer with an appropriate priority according to the importance degree of the data.

The configuration register 103 may store the priority information, and the priority information may include the priority of each sending buffer in the multi-core system. The priority arbitration module 104 may select the sending buffer with the highest priority from the plurality of sending buffers storing the data to be transmitted according to the priority information. Here, the plurality of sending buffers storing the data to be transmitted may belong to different processor cores. In this way, the data transit module 101 may control the DMA module to transmit in priority the data in the sending buffer with the highest priority according to the selecting result of the priority arbitration module 104. For example, the above first sending buffer has the highest priority in all the sending buffer storing the data to be transmitted, so the data transit module 101 may read the configuration information of the first sending buffer from the configuration register 103 according to the indication information sent by the priority arbitration module 104, to process the data of the first sending buffer in priority. Thereby, it can be ensured that the important data is transmitted in priority.

Optionally, as another embodiment, the interrupt management module 102 may control, when the interrupt information indicates that the data amount in the receiving buffer is greater than or equal to a data amount threshold, the multi-core interrupt controller to trigger an interrupt to the second processor core. Alternatively, the interrupt management module 102 may control, when an interrupt time threshold indicated by the interrupt information expires, the multi-core interrupt controller to trigger the interrupt to the second processor core. Alternatively, the interrupt management module 102 may control, when the interrupt information indicates that the data has been transmitted from the first sending buffer to the receiving buffer, the multi-core interrupt controller to trigger the interrupt to the second processor core.

Specifically, there are various interrupt triggering manners. For example, an interrupt triggering manner setting the interrupt time threshold in combination with the data amount threshold may be adopted. The data amount of the receiving buffer may be determined according to the configuration information of the receiving buffer, for example, may be determined according to the write pointer and the read pointer of the receiving buffer. The interrupt information may further include a timer, for timing a time length of storing the data in the receiving buffer. Therefore, the interrupt time threshold and the data amount threshold can be reasonably set according to the actual performance of the processor core, thereby effectively reducing the CPU usage rate of the second processor core. Moreover, the manner of triggering the interrupt each time a data packet is transmitted may also be adopted.

Optionally, as another embodiment, FIG. 2 is a schematic block diagram of a data transmission apparatus according to another embodiment of the present invention. As shown in FIG. 2, the apparatus 100 may also include a DMA module 105.

Moreover, the DMA module may also be an external module of the apparatus 100, which is not limited in the embodiment of the present invention and FIG. 2.

Optionally, as another embodiment, as shown in FIG. 2, the apparatus 100 may also include a coding module 106, a processing buffer 107, and a cyclic redundancy check (Cyclic Redundancy Check, CRC) generation module 108.

The data transit module 101 may control the DMA module to transmit the data from the first sending buffer to the processing buffer. The coding module 106 may code the data, and transmit the coded data to the CRC generation module 108. The CRC generation module 108 may perform CRC check on the coded data, and store the data after the CRC check in the processing buffer 107. The data transit module 101 may control the DMA module to transmit the data after the CRC check from the processing buffer 107 to the receiving buffer.

For example, the coding module 106 may perform high-level data link control (High-level Data Link Control, HDLC) coding or other similar coding on the data, to demarcate the transmitted data packets.

Optionally, as another embodiment, the apparatus 100 may further include an integrity detection module 109. The integrity detection module 109 may, before the data transit module 101 controls the DMA module to transmit the data from the first sending buffer to the receiving buffer, perform integrity detection on the data.

In the embodiment of the present invention, the data transit module controls the DMA module to transmit the data from the first sending buffer of the first processor core to the receiving buffer of the second processor core, and the interrupt management module controls the multi-core interrupt controller to trigger the interrupt to the second processor core, so that the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

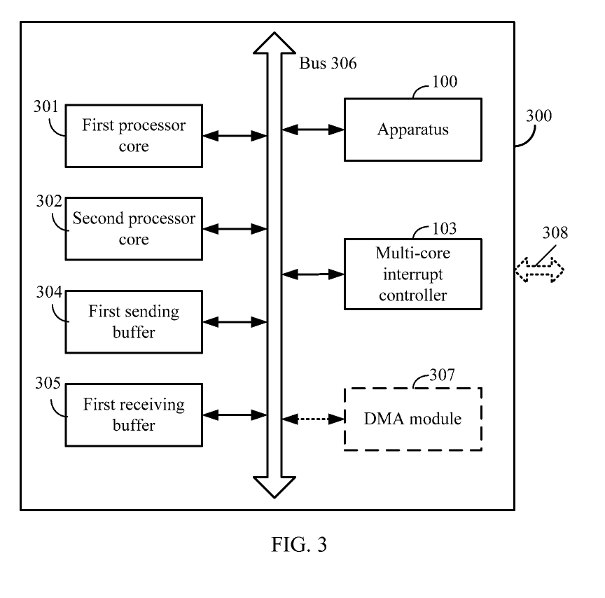

FIG. 3 is a schematic block diagram of a data transmission system according to an embodiment of the present invention.

The system 300 in FIG. 3 includes at least two processor cores, for example, a first processor core 301 and a second processor core 302 in FIG. 3, and the system 300 further includes a multi-core interrupt controller 303 and an apparatus 100.

The first processor core 301 may be configured with at least one sending buffer, for example, the first sending buffer 304 shown in FIG. 3. The second processor core 302 may be configured with at least one receiving buffer, for example, a first receiving buffer 305 shown in FIG. 3.

It should be noted that, for the convenience of description, two processor cores 301 and 302 are shown in FIG. 3, but in the embodiment of the present invention, the number of processor cores may be larger.

It should also be noted that, for the convenience of description, in FIG. 3, the first sending buffer 304 is configured for the first processor core 301, and the first receiving buffer 305 is configured for the second processor core 302. However, in the embodiment of the present invention, the number of sending buffers configured in the first processor core 301 and the number of receiving buffers configured in the second processor core 302 may also be larger.

The first processor core 301, the second processor core 302, the first sending buffer 304, the first receiving buffer 305, the multi-core interrupt controller 303, and the apparatus 100 are connected through a bus 306.

The first processor core 301 may write the data to be transmitted to the first receiving buffer 305 of the second processor core 302 into the first sending buffer 304.

The apparatus 100 may control, when the configuration information of the first sending buffer 304 indicates that the first sending buffer 304 stores the data to be transmitted to the first receiving buffer 305, the DMA module to transmit the data from the first sending buffer 304 to the first receiving buffer 305, and set the interrupt information.

The apparatus 100 may further control, when the interrupt information indicates that an interrupt needs to be triggered to the second processor 302, the multi-core interrupt controller 303 to trigger the interrupt to the second processor core 302. The apparatus 100 may specifically have the structure of the embodiment shown in FIG. 1 or FIG. 2.

The second processor core 302 may process the data in the first receiving buffer 305 in response to the interrupt triggered by the apparatus 100.

In the embodiment of the present invention, the data transmission apparatus transmits the data from the first sending buffer of the first processor core to the first receiving buffer of the second processor core and controls the multi-core interrupt controller to trigger the interrupt to the second processor core, so that the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

Moreover, since the first processor core and the second processor core do not need to perform relevant operations of data transmission and interrupt triggering in the inter-core communication process, a huge throughput is provided, thereby ensuring real-time data transmission between the multiple processor cores, and ensuring real-time processing of the service.

It should be understood that, in the embodiment of the present invention, in an initial state of the system, one master processor core may be determined from the at least two processor cores, and the master processor core configure each sending buffer and each receiving buffer, to generate the configuration information of the sending buffer and the configuration information of the receiving buffer. The master processor core may further configure the apparatus 100. Moreover, each processor core may also configure its own sending buffer or receiving buffer, to generate the configuration information of the sending buffers and the configuration information of the receiving buffers.

It should also be understood that, in the embodiment of the present invention, the sending buffer and the receiving buffer may be located in different types of random access memories (RAM, Random Access Memory), for example, an SRAM (Static RAM, static RAM), a DRAM (Dynamic RAM, dynamic RAM), or the like.

Optionally, as an embodiment, the system 300 may further include a DMA module 307. The DMA module 307 may be connected to the processor core 301, the processor core 302, the sending buffer 304, the receiving buffer 305, the multi-core interrupt controller 303, and the apparatus 100 through the bus 306. For example, the bus 306 may be various interconnecting bus such as AXI or Crossbar.

Moreover, the DMA module 307 may also be built in the apparatus 100, which is not limited in the embodiment of the present invention.

Optionally, as another embodiment, the system 300 may further include a serial interface 308, and the system 300 may be connected to another system through the serial interface 308. The apparatus 100 may also code the data to be transmitted stored in the plurality of sending buffers to acquire coded data, and transmit the coded data to a receiving buffer of the at least one receiving buffer to acquire aggregated data. The serial interface 308 may read the aggregated data, and transmit the aggregated data to the another system.

For example, the apparatus 100 may perform HDLC coding or other similar coding on the data to be transmitted stored in the plurality of sending buffers, to acquire the coded data. The coded data may also be transmitted to the receiving buffer, to acquire the aggregated data. Thereby, each data to be transmitted in each sending buffer may be demarcated by coding. The coded data is transmitted to a receiving buffer, to implement serial convergence of data packets. The system 300 may also transmit the aggregated data to the another system, for example, through the serial interface, such as a USB (Universal Serial Bus, universal serial bus), an Ethernet port, or a high speed serial port, to implement data transmission between systems. A typical application is aggregating diagnosis information generated by a plurality of processor cores to one processor core in series, and then transmitting the information to a background tool on a PC through a serial interface, to intensively perform analysis and processing.

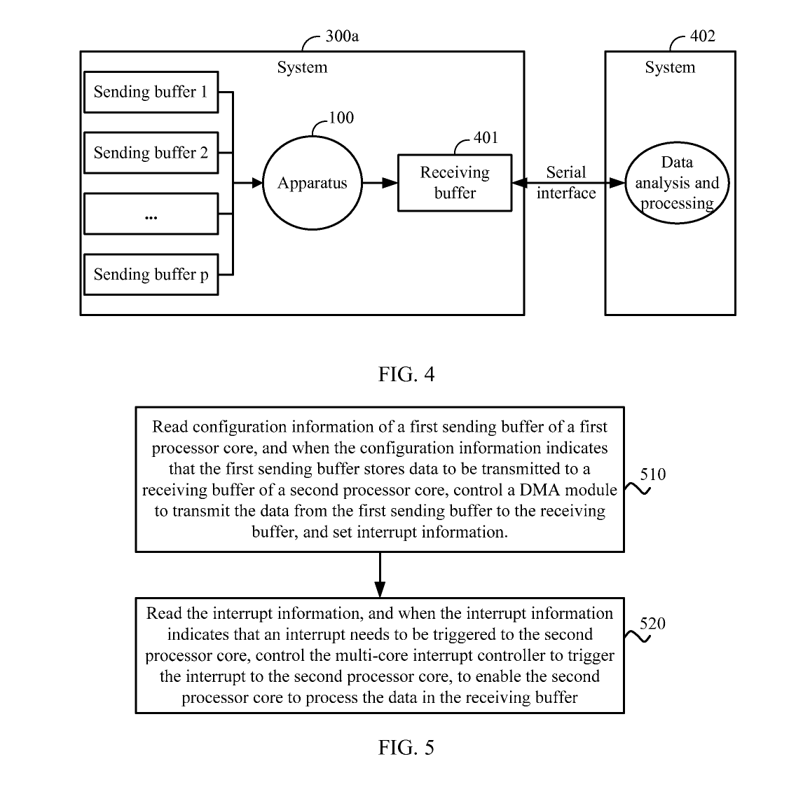

Hereinafter, the data transmission process between systems is illustrated in detail with reference to specific examples. FIG. 4 is a schematic flow chart of an example of transmitting data between systems according to an embodiment of the present invention.

As shown in FIG. 4, in a system 300a, it is assumed that there are p sending buffers, namely, sending buffer 1 to sending buffer p, where p is a positive integer. Each sending buffer stores the data to be transmitted. The apparatus 100 may code the data to be transmitted in the sending buffer 1 to the sending buffer p to obtain coded data, and then the coded data is transmitted to a receiving buffer 401. The system 300a may send the data to the system 402 through the serial interface, such as a universal serial bus (Universal Serial Bus, universal serial bus), an Ethernet port, or a high speed serial port. The system 402 may perform analysis and processing on the received data, thereby implementing the data transmission between the systems.

FIG. 5 is a schematic flow chart of a data transmission method according to an embodiment of the present invention. The method in FIG. 5 is executed by the data transmission apparatus, for example the apparatus 100 shown in FIG. 1 to FIG. 4.

510. An apparatus 100 reads configuration information of a first sending buffer of a first processor core, and when the configuration information indicates that the first sending buffer stores data to be transmitted to a receiving buffer of a second processor core, controls a DMA module to transmit the data from the first sending buffer to the receiving buffer, and sets interrupt information.

520. The apparatus 100 reads the interrupt information, and when the interrupt information indicates that an interrupt needs to be triggered to the second processor core, controls the multi-core interrupt controller to trigger the interrupt to the second processor core, to enable the second processor core to process the data in the receiving buffer.

In the embodiment of the present invention, the DMA module is controlled to transmit the data from the first sending buffer of the first processor core to the receiving buffer of the second processor core, and the multi-core interrupt controller is controlled to trigger the interrupt to the second processor core. In this way, the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

Optionally, as an embodiment, the apparatus 100 may select the first sending buffer from a plurality of sending buffers storing the data to be transmitted according to the priority information, where the first sending buffer has the highest priority in the plurality of sending buffers storing the data to be transmitted, and the priority information includes the priority of each sending buffer.

Optionally, as another embodiment, the apparatus 100 may control, when the interrupt information indicates that the data amount in the receiving buffer is greater than or equal to a data amount threshold, the multi-core interrupt controller to trigger an interrupt to the second processor core. Alternatively, the apparatus 100 may control, when a time length of an interrupt time threshold indicated by the interrupt information expires, the multi-core interrupt controller to trigger the interrupt to the second processor core. Alternatively, the apparatus 100 may control, when the interrupt information indicates that the data has been transmitted from the first sending buffer to the receiving buffer, the multi-core interrupt controller to trigger the interrupt to the second processor core.

Optionally, as another embodiment, the apparatus 100 may control the DMA module to transmit the data from the first sending buffer to the processing buffer; code the data; perform CRC check on the coded data, and store the data after the CRC check in the processing buffer; and control the DMA module to transmit the data after the CRC check from the processing buffer to the receiving buffer.

Optionally, as another embodiment, the apparatus 100 may perform, before controlling the DMA module to transmit the data from the first sending buffer to the receiving buffer, integrity detection on the data.

For other specific processes of the method in FIG. 5, reference may be made to the specific functions and operations of the apparatus 100 in FIG. 1 to FIG. 4, which are not repeated herein in order to avoid repetition.

In the embodiments of the present invention, the DMA module is controlled to transmit the data from the first sending buffer of the first processor core to the receiving buffer of the second processor core, and the multi-core interrupt controller is controlled to trigger the interrupt to the second processor core, so that the first processor core and the second processor core do not need to perform relevant operations of data transmission and interrupt triggering in the inter-core communication process, thereby reducing consumption of the processor cores in an inter-core communication process, enhancing service processing capabilities of the processor cores and improving data transmission rate between the multiple processor cores.

Persons of ordinary skill in the art should understand that, in combination with the embodiments herein, steps of the method or algorithm described may be directly implemented using hardware, a software module executed by a processor, or the combination thereof. Whether these functions are executed as hardware or software depends upon the particular application and design constraint conditions of the technical solution. Persons skilled in the art can use different methods to implement the described functions for each particular application, but it should not be considered that the implementation goes beyond the scope of the present invention.

It can be clearly understood by persons skilled in the art that, for the purpose of convenient and brief description, for a detailed working process of the foregoing system, device and unit, reference may be made to the corresponding process in the method embodiments, and the details will not be described herein again.

In several embodiments provided in the present application, it should be understood that the disclosed system, device, and method may be implemented in other ways. For example, the described device embodiments are merely exemplary. For example, the unit division is merely logical function division and can be other division in actual implementation. For example, multiple units or components can be combined or integrated into another system, or some features can be ignored or not performed. Furthermore, the shown or discussed coupling or direct coupling or communication connection may be accomplished through some interfaces, and indirect coupling or communication connection between devices or units may be electrical, mechanical, or in other forms.

Units described as separate components may be or may not be physically separated. Components shown as units may be or may not be physical units, that is, may be integrated or distributed to a plurality of network units. Some or all of the modules may be selected to achieve the objective of the solution of the embodiment according to actual demands.

In addition, various functional units according to each embodiment of the present invention may be integrated in one processing module or may exist as various separate physical units, or two or more units may also be integrated in one unit.

When the integrated module is implemented in the form of the software functional module and sold or used as a separate product, the integrated module may be stored in a computer readable storage medium. Therefore, the technical solution of the present invention or the part that makes contributions to the prior art can be substantially embodied in the form of a software product. The computer software product is stored in a storage medium, and contains several instructions to instruct computer equipment (such as, a personal computer, a server, or network equipment) to perform all or part of steps of the method as described in the embodiments of the present invention. The storage medium includes various media capable of storing program codes, such as, a flash disk, a mobile hard disk, a read-only memory (ROM, Read-Only Memory), a random access memory (RAM, Random Access Memory), a magnetic disk or an optical disk.

The foregoing descriptions are merely specific embodiments of the present invention, but are not intended to limit the protection scope of the present invention. Various equivalent modifications or replacements may be easily figured out by any person skilled in the art without departing from the disclosed technical scope of the present invention, and the modifications or replacements shall all fall within the protection scope of the present invention. Therefore, the protection scope of the present invention is subject to the appended claims.

1. A data transmission apparatus, comprising:
a data transit module, configured to read configuration information of a first sending buffer of a first processor core, and when the configuration information indicates that the first sending buffer stores data to be transmitted to a receiving buffer of a second processor core, control a Direct Memory Access (DMA) module to transmit the data from the first sending buffer to the receiving buffer, and set interrupt information; and
an interrupt management module, configured to read the interrupt information, and when the interrupt information indicates that an interrupt needs to be triggered to the second processor core, control a multi-core interrupt controller to trigger the interrupt to the second processor core, to enable the second processor core to process the data in the receiving buffer.

2. The apparatus according to claim 1, further comprising: a configuration register, configured to store the configuration information and the interrupt information; wherein
the data transit module is configured to read the configuration information from the configuration register, and store the interrupt information into the configuration register; and
the interrupt management module is configured to read the interrupt information from the configuration register.

3. The apparatus according to claim 2, further comprising a priority arbitration module, wherein
the configuration register is further configured to store priority information, the priority information comprising a priority of each sending buffer;
the priority arbitration module is configured to select the first sending buffer from a plurality of sending buffers storing the data to be transmitted according to the priority information, and send indication information for indicating the first sending buffer to the data transit module, wherein the first sending buffer has the highest priority in the plurality of sending buffers storing the data to be transmitted; and
the data transit module is configured to read the configuration information of the first sending buffer from the configuration register according to the indication information.

4. The apparatus according to claim 1, wherein
the interrupt management module is configured to control, when the interrupt information indicates that an amount of data in the receiving buffer is greater than or equal to a data amount threshold, the multi-core interrupt controller to trigger the interrupt to the second processor core.

5. The apparatus according to claim 1, further comprising the DMA module.

6. The apparatus according to claim 1, further comprising a coding module, a processing buffer, and a Cyclic Redundancy Check (CRC) generation module; wherein
the data transit module is configured to control the DMA module to transmit the data from the first sending buffer to the processing buffer;
the coding module is configured to code the data, and transmit the coded data to the CRC generation module;
the CRC generation module is configured to perform CRC check on the coded data, and store the data after the CRC check in the processing buffer; and
the data transit module is configured to control the DMA module to transmit the data after the CRC check from the processing buffer to the receiving buffer.

7. The apparatus according to claim 1, further comprising:
an integrity detection module, configured to perform, before the data transit module controls the DMA module to transmit the data from the first sending buffer to the receiving buffer, integrity detection on the data.

8. A data transmission system, comprising:
at least two processor cores, a multi-core interrupt controller, and a data transmission apparatus, wherein
a first processor core in the at least two processor cores is configured with at least one sending buffer, and a second processor core in the at least two processor cores is configured with at least one receiving buffer;
the at least two processor cores, the at least one sending buffer, the at least one receiving buffer, the multi-core interrupt controller, and the data transmission apparatus are connected through a bus;
the first processor core is configured to write data to be transmitted to a first receiving buffer in the at least one receiving buffer into a first sending buffer in the at least one sending buffer;
the data transmission apparatus is configured to:
when configuration information of the first sending buffer indicates that the first sending buffer stores data to be transmitted to the first receiving buffer, control a Direct Memory Access (DMA) module to transmit the data from the first sending buffer to the first receiving buffer, and set interrupt information, and
when the interrupt information indicates that an interrupt needs to be triggered to the second processor core, control a multi-core interrupt controller to trigger the interrupt to the second processor core; and
the second processor core is configured to process the data in the first receiving buffer in response to the interrupt triggered by the data transmission apparatus.

9. The system according to claim 8, further comprising:
the DMA module, connected to the at least two processor cores, the at least one sending buffer, the at least one receiving buffer, the multi-core interrupt controller, and the data transmission apparatus through the bus.

10. The system according to claim 8, further comprising: a serial interface, wherein the system is connected to another system through the serial interface;
the data transmission apparatus is further configured to code the data to be transmitted stored in the plurality of sending buffers to acquire coded data, and transmit the coded data to a receiving buffer of the at least one receiving buffer to acquire aggregated data; and
the serial interface is configured to read the aggregated data, and transmit the aggregated data to the another system.

11. A data transmission method, comprising:
reading configuration information of a first sending buffer of a first processor core, and when the configuration information indicates that the first sending buffer stores data to be transmitted to a receiving buffer of a second processor core, controlling a Direct Memory Access (DMA) module to transmit the data from the first sending buffer to the receiving buffer, and setting interrupt information; and
reading the interrupt information, and when the interrupt information indicates that an interrupt needs to be triggered to the second processor core, controlling a multi-core interrupt controller to trigger the interrupt to the second processor core, to enable the second processor core to process the data in the receiving buffer.

12. The method according to claim 11, further comprising:
according to priority information, selecting the first sending buffer from a plurality of sending buffers storing the data to be transmitted, wherein the first sending buffer has the highest priority in the plurality of sending buffers storing the data to be transmitted, and the priority information comprises a priority of each sending buffer.

13. The method according to claim 11, wherein the controlling, when the interrupt information indicates that an interrupt needs to be triggered to the second processor core, a multi-core interrupt controller to trigger the interrupt to the second processor core comprises:
when the interrupt information indicates that data amount in the receiving buffer is greater than or equal to a data amount threshold, controlling the multi-core interrupt controller to trigger the interrupt to the second processor core.

14. The method according to claim 11, wherein the controlling the DMA module to transmit the data from the first sending buffer to the receiving buffer comprises:
controlling the DMA module to transmit the data from the first sending buffer to a processing buffer;
coding the data;
performing CRC check on the coded data, and storing the data after the CRC check in the processing buffer; and
controlling the DMA module to transmit the data after the CRC check from the processing buffer to the receiving buffer.

15. The method according to claim 11, further comprising:
before the controlling the DMA module to transmit the data from the first sending buffer to the receiving buffer, performing integrity detection on the data.

16. The apparatus according to claim 1, wherein
the interrupt management module is configured to control, when a time length of an interrupt time threshold indicated by the interrupt information expires, the multi-core interrupt controller to trigger the interrupt to the second processor core.

17. The apparatus according to claim 1, wherein
the interrupt management module is configured to control, when the interrupt information indicates that the data has been transmitted from the first sending buffer to the receiving buffer, the multi-core interrupt controller to trigger the interrupt to the second processor core.

18. The method according to claim 11, wherein the controlling, when the interrupt information indicates that an interrupt needs to be triggered to the second processor core, a multi-core interrupt controller to trigger the interrupt to the second processor core comprises:
when a time length of an interrupt time threshold indicated by the interrupt information expires, controlling the multi-core interrupt controller to trigger the interrupt to the second processor core.

19. The method according to claim 11, wherein the controlling, when the interrupt information indicates that an interrupt needs to be triggered to the second processor core, a multi-core interrupt controller to trigger the interrupt to the second processor core comprises:
when the interrupt information indicates that the data has been transmitted from the first sending buffer to the receiving buffer, controlling the multi-core interrupt controller to trigger the interrupt to the second processor core.
